(19) United States
(12) Patent Application Publication
(10) Pub. No.: US 2014/0189157 A1
(43) Pub. Date: Jul. 3, 2014

(54) ENERGY MANAGEMENT FOR COMMUNICATION NETWORK ELEMENTS

(71) Applicant: International Business Machines Corporation, (US)

(72) Inventors: Casimer M. DeCusatis, Poughkeepsie, NY (US); Rajaram B. Krishnamurthy, Wappingers Falls, NY (US); Michael Onghena, Poughquag, NY (US); Anuradha Rao, Hopewell Junction, NY (US)

(73) Assignee: INTERNATIONAL BUSINESS MACHINES CORPORATION, Armonk, NY (US)

(21) Appl. No.: 13/733,158

(22) Filed: Jan. 3, 2013

(51) Int. Cl. H04L 12/56

(52) U.S. Cl. CPC H04L 45/38
USPC 709/238

(57) ABSTRACT

A method of managing data flow may include determining data flows as one of data flows of known duration (KD) and data flows of arbitrary duration (AD). Profile energy consumption values for each of the KD flows is determined based on transmitting the KD flows between a first and a second node via a first network adaptor port, a second network adaptor port card, and switch port cards. Energy efficient routes for transmitting the KD flows between the nodes are also determined. Based on the profile energy consumption values, network element reference energy consumption values for each of network adaptor port cards and each of switch port cards located along the routes are determined, whereby transmission of the KD flows is based on energy consumption values at each of network adaptor port cards and each of switch port cards not exceeding respective network element reference energy consumption values.

### BACKGROUND

a. Field of the Invention

The present invention generally relates to communication networks, and particularly, to managing energy consumption within network communication equipment.

b. Background of Invention

Communication equipment such as network adaptors, routers, and switches are responsible for conveying data from one user to an intended other user using various communication protocols. Routing protocols, which determine how routers and/or switches communicate with each other across a communication network, may spread the flow of data traffic across various routers/switches/adaptors in order to reduce data latency. However, such a reduction of data latency may be accomplished at the expense of an increase in energy consumption within the routers/switches/adaptors in the data path.

It may, therefore, be advantageous, among other things, to manage the consumption of energy by the various elements of a communications network such as routers, switches, network adaptors, etc.

### BRIEF SUMMARY

According to at least one exemplary embodiment, a method of managing data flow between a first node and a second node within a communication network is provided. The method may include determining data flows as at least one of data flows of known duration and data flows of arbitrary duration. Profile energy consumption values for each of the data flows of known duration are determined based on transmitting the data flows of known duration between the first and the second node via a first network adaptor port card associated with the first node, a second network adaptor port card associated with the second node, and switch port cards for communicatively coupling the first and the second network adaptor port card. One or more energy efficient routes for transmitting the data flows of known duration between the first and the second node over the communication network are then determined. Based on the profile energy consumption values, network element reference energy consumption values are determined for each of network adaptor port cards and each of switch port cards located along the one or more energy efficient routes, whereby transmission of the data flows of known duration is based on energy consumption values at each of network adaptor port cards and each of switch port cards not exceeding a respective one of the network element reference energy consumption values.

According to at least one other exemplary embodiment, a computer system for managing data flow between a first node and a second node within a communication network may include a memory and a processor in communication with the memory, whereby the processor includes an instruction fetching unit for fetching instructions from memory and one or more execution units for executing fetched instructions. The computer system is capable of performing a method including determining data flows as at least one of data flows of known duration and data flows of arbitrary duration. Profile energy consumption values for each of the data flows of known duration are determined based on transmitting the data flows of known duration between the first and the second node via a first network adaptor port card associated with the first node, a second network adaptor port card associated with the second node, and switch port cards for communicatively coupling the first and the second network adaptor port card. One or more energy efficient routes for transmitting the data flows of known duration between the first and the second node over the communication network are then determined. Based on the profile energy consumption values, network element reference energy consumption values are determined for each of network adaptor port cards and each of switch port cards located along the one or more energy efficient routes, whereby transmission of the data flows of known duration is based on energy consumption values at each of network adaptor port cards and each of switch port cards not exceeding a respective one of the network element reference energy consumption values.

According to at least one other exemplary embodiment, a computer program product for storing a computer program for managing data flow between a first node and a second node within a communication network is provided. The computer program product may include a storage medium that is readable by a processing circuit and stores instructions for execution by the processing circuit for performing a method that includes determining data flows as at least one of data flows of known duration and data flows of arbitrary duration. Profile energy consumption values for each of the data flows of known duration are determined based on transmitting the data flows of known duration between the first and the second node via a first network adaptor port card associated with the first node, a second network adaptor port card associated with the second node, and switch port cards for communicatively coupling the first and the second network adaptor port card. One or more energy efficient routes for transmitting the data flows of known duration between the first and the second node over the communication network are then determined. Based on the profile energy consumption values, network element reference energy consumption values are determined for each of network adaptor port cards and each of switch port cards located along the one or more energy efficient routes, whereby transmission of the data flows of known duration is based on energy consumption values at each of network adaptor port cards and each of switch port cards not exceeding a respective one of the network element reference energy consumption values.

### BRIEF DESCRIPTION OF THE SEVERAL VIEWS OF THE DRAWINGS

FIG. 1 is a block diagram of a communication system employing an energy management scheme according to one or more exemplary embodiments;

FIGS. 2A-2C are operational flow diagrams of a forward-allocation energy management scheme according to one exemplary embodiment;

FIG. 3 is operational flow diagram of a data classification process associated with arbitrary data flows according to one exemplary embodiment; and

FIG. 4 is a block diagram of hardware and software within the computer(s) of FIG. 1 in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The described exemplary embodiment is directed to the management of energy consumption across communication networks by assigning and monitoring energy budgets (i.e., an energy management scheme) for various communications equipment along one or more communication paths.

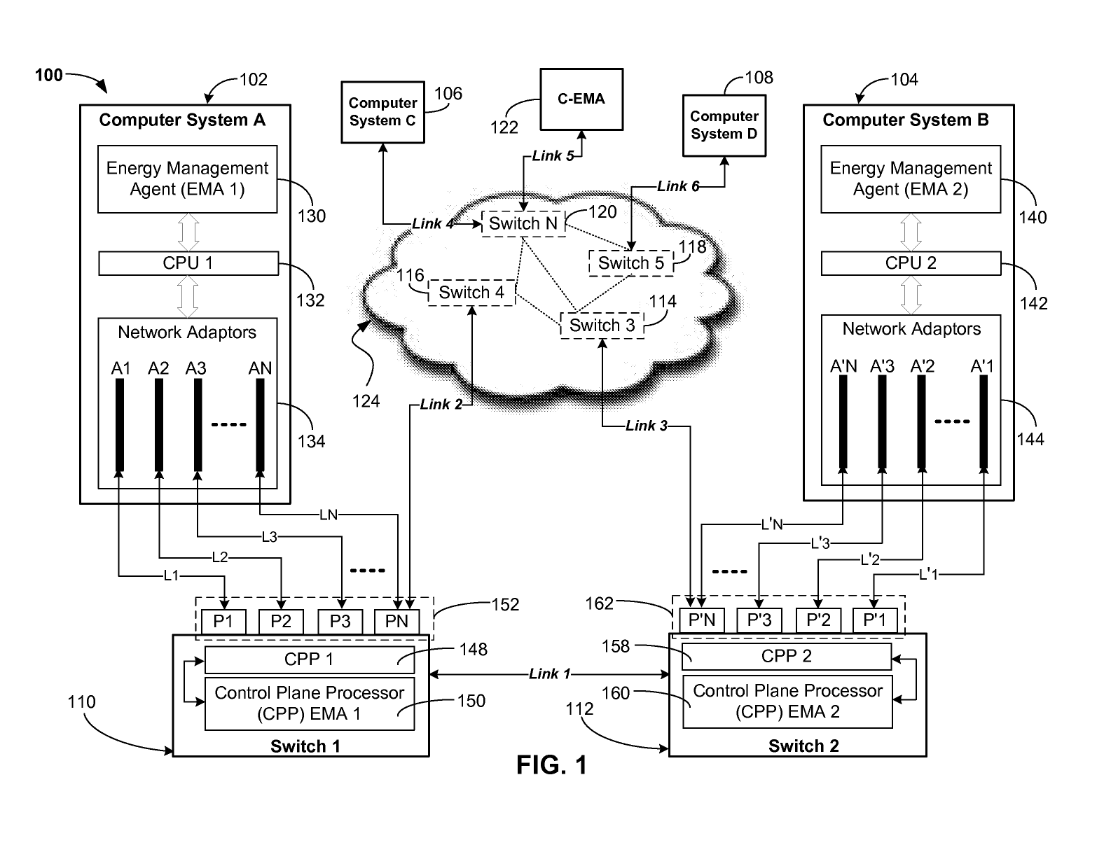

Referring to FIG. 1, a block diagram of a communication system 100 employing an energy management scheme according to an exemplary embodiment is depicted. The communication system 100 may, for example, include computer systems 102, 104, 106, and 108; switch devices 110, 112, 114, 116, 118, and 120, a central energy management agent 122; and communication network 124. According to some implementations, computer systems 102, 104, 106, and 108 may, for example, include computer data centers that send and/or receive data flows, while communication network 124 may, for example, include a Storage Area Network (SAN).

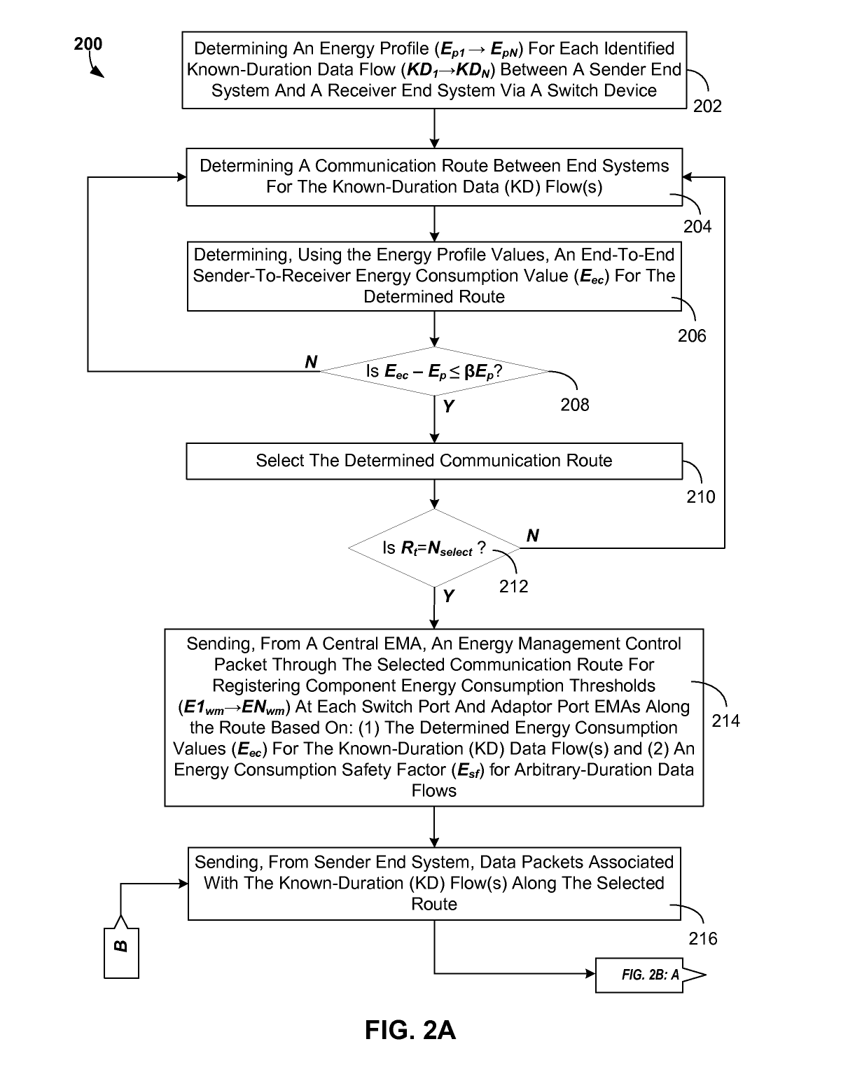

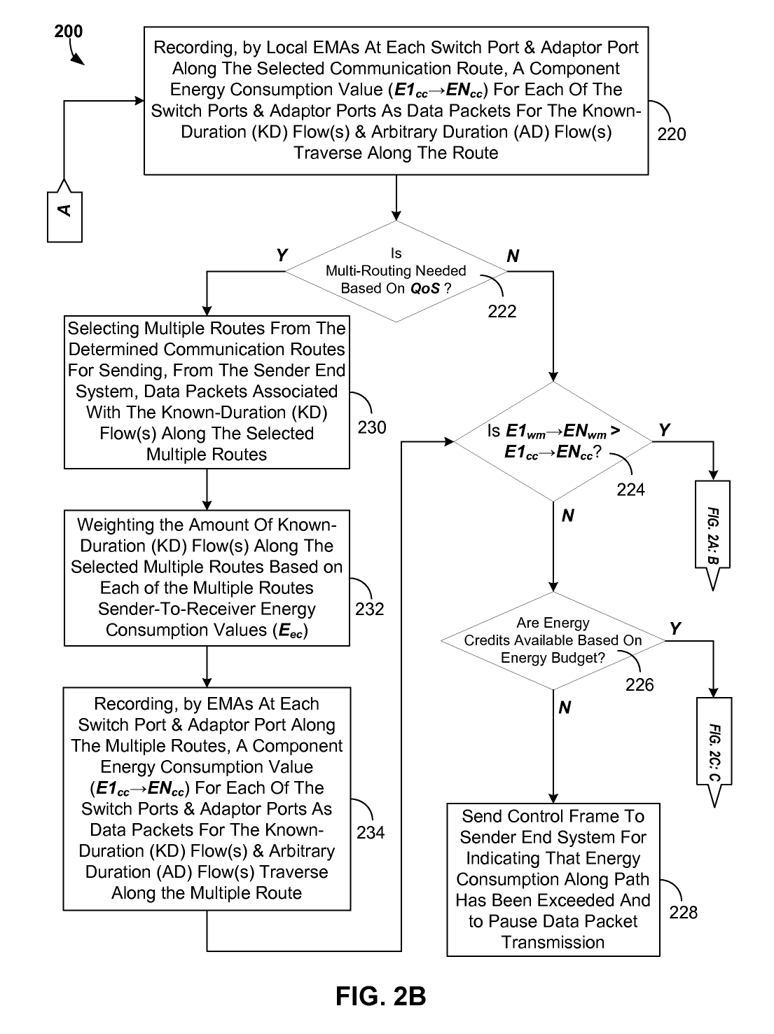

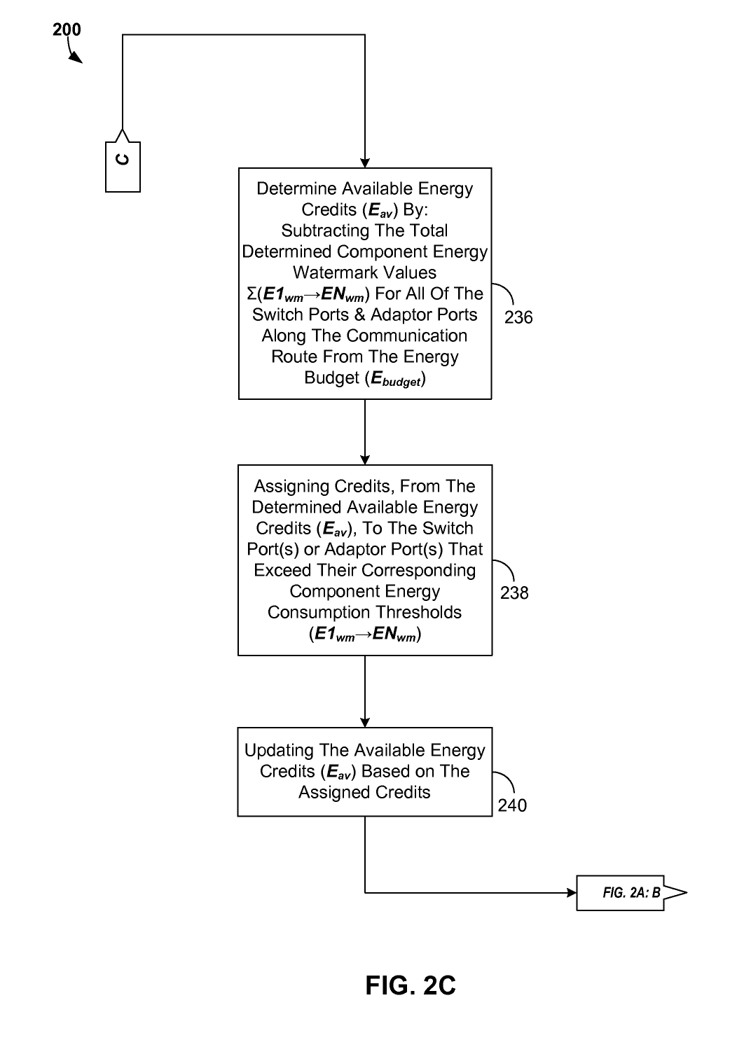

Computer system 102 may include an energy management agent (EMA) component 130, a central processing unit (CPU) 132 in communication with the EMA component 130, and network adaptors 134 for transmitting and receiving data between switch device 110 and CPU 132. As depicted, the network adaptors 134 may include a plurality network adaptor port cards A1-AN each having input/output ports for receiving and transmitting data. In some implementations, the energy management agent (EMA) component 130 may be software or firmware running on a dedicated processor device (e.g., microprocessor). In other implementations, the energy management agent (EMA) component 130 may be incorporated within, and executed by, the CPU 132. The EMA component 130 may monitor and manage the energy consumption of the network adaptor port cards A1-AN utilized over one or more communication routes. Details of the operation of an example EMA component such as EMA 130 are described below with the aid of FIGS. 2A-2C.

Similarly, computer system 104 may include an energy management agent (EMA) component 140, a central processing unit (CPU) 142 in communication with the EMA component 140, and network adaptors 144 for transmitting and receiving data between switch device 112 and CPU 142. As depicted, the network adaptors 144 may include a plurality of network adaptor port cards A1-AN each having input/output ports for receiving and transmitting data. In some implementations, the energy management agent (EMA) component 140 may be software or firmware running on a dedicated processor device (e.g., microprocessor). In other implementations, the energy management agent (EMA) component 140 may be incorporated within and executed by the CPU 142. Computer systems 106 and 108 may be identical or similar to computer systems 102 or 104. The EMA component 140 may monitor and manage the energy consumption of the network adaptor port cards A′1-A′N utilized over one or more communication routes. Details of the operation of an example EMA component such as EMA 140 are described below with the aid of FIGS. 2A-2C.

Switch device 110 may include a control plane processor (CPP) 148, a control plane processor EMA component 150, and switch cards 152 for transmitting and receiving data between network adaptor port cards A1-AN and other switch devices (e.g., Switch 1 and Switch 4). As depicted, the switch cards 152 may include a plurality of switch port cards P1-PN each having input/output ports for receiving and transmitting data between, for example, respective network adaptor port cards A1-AN over links L1-LN. The plurality of switch port cards P1-PN may also provide connectivity with other switch devices. For example, switch port card PN may provide a communication link (i.e., Link 2) between switch 110 and switch 116 over communication network 124. The control plane processor EMA component 150 may monitor and manage the energy consumption of the switch port cards P1-PN utilized over one or more communication routes. Details of the operation of an example EMA component such as EMA 150 are described below with the aid of FIG. 2A-2C.

Also, switch device 112 may include a control plane processor (CPP) 158, a control plane processor EMA component 160, and switch cards 162 for transmitting and receiving data between network adaptor port cards A′1-A′N and other switch devices (e.g., Switch 2 and Switch 3). As depicted, the switch cards 162 may include a plurality of switch port cards P′1-P′N each having input/output ports for receiving and transmitting data between, for example, respective network adaptor port cards A′1-A′N over links L′1-L′N. The plurality of switch port cards P′1-P′N may also provide connectivity with other switch devices. For example, switch port card P′N may provide a communication link (i.e., Link 3) between switch 112 and switch 114 over communication network 124. The control plane processor EMA component 160 may monitor and manage the energy consumption of the switch port cards P′1-P′N utilized over one or more communication routes. Details of the operation of an example EMA component such as EMA 160 are described below with the aid of FIGS. 2A-2C. Switch devices 114-120 may be identical or similar to switch devices systems 110 or 112.

According to some implementations, a central EMA component (C-EMA) 122 may be in communication with and manage the operation of EMA components 130, 140, 150, and 160 via network 124. Thus, the C-EMA component 122 may run on a dedicated computer device and provide configuration data to, and receive status information from, the other EMA components 130, 140, 150, 160. According to other implementations, for example, any one of EMA components 130, 140, 150, and 160 may act as a central EMA component, whereby allocation of EMA components 130, 140, 150, and 160 as a central EMA component may be accomplished dynamically based various user-defined conditions. For example, one user-defined condition may include assigning a particular EMA component 130, 140, 150, 160 as a central EMA component based on the EMA residing at a sender-end location. According to another example, a user-defined condition may include assigning a particular EMA component 130, 140, 150, 160 as a central EMA component based on the EMA residing at a receiver location. According to yet another example, a user-defined condition may include assigning a particular EMA component 130, 140, 150, 160 as a central EMA component based on the amount of data traffic handled at the EMA component location.

As previously indicated, the EMA components may, among other things, monitor and manage energy consumption within the network adaptor port cards and switch cards. Thus, energy metering devices (e.g., energy metering integrated circuit devices) may be used in connection with the network adaptor port cards and switch port cards in order to determine their instantaneous energy consumption values.

As shown in FIG. 1, switch devices 110-120 are in communication. Some switches may be directly coupled to each other, such as switch device 110 and switch device 112. In such an implementation, the switches 110, 112 may be located in the same physical location. Alternatively, some switches may be coupled to each other via communication network 124. For example, switch device 110 may connect to switches 116 and 120 via communications network 124, whereby the communication network may, for example, include a local area network (LAN), metropolitan area network (MAN), or wide area network (WAN) of either a wireless or wired type.

FIGS. 2A-2C are operational flow diagrams 200 of a forward-allocation energy management scheme according to one exemplary embodiment. FIGS. 2A-2C will be described with the aid the exemplary communication system 100 illustrated in FIG. 1. Referring to FIG. 2A, at 202, an energy profile (Eₚ) for each identified known-duration (KD) data flow between a sender end system and a receiver end system is determined, whereby the sender end system and the receiver end system are connected via a switch device. A KD data flow may include data that is associated with a known service, which may be profiled. Another category of data is arbitrary data (AD) flows, which may include data traffic that is bursty and of an unknown and arbitrary duration such as web traffic. AD data flows are not profiled.

For example, an energy profile run for each KD data flow may be carried out between computer system 102 and computer system 104 via switch device 110. The energy profile determinations are then subsequently utilized to calculate energy threshold values at each of the adaptor port cards (e.g., A′1-A′N) and switch port cards (e.g., P′1-P′N) utilized over one or more designated communication routes. Example KD data flows may be data from sensor devices, information stored in databases, application software data, backup operation data or other data of known volume and bandwidth. During the energy profile run, KD data (e.g., KD1) may be transmitted from sender end computer system 102 through a network adaptor port card (e.g., A1) and an input switch port card (e.g., P1), to output switch port card PN, and then to a network adaptor port card (e.g., A′1) at the receiver end computer system 104. During such a profile run, it may be determined from energy metering that the energy consumption (i.e., Power (Watts)×Time (hours)) of network adaptor port card A1 may be 20 KWh, the energy consumption of input switch port card P1 (switch 110) may be 30 KWh, the energy consumption of the output Switch port card PN (switch 110) may be 30 KWh, and the energy consumption (i.e., Power (Watts)×Time (hours)) of network adaptor port card A′1 may be 20 KWh. As subsequently described below, the energy consumption determination associated with the switch port card (e.g., P1 is 30 KWh) during the profile run may be used to ascertain a baseline energy consumption value for various switch devices along a designated route between sender and receiver end computer systems. Thus, the energy profile (Eₚ) for the KD1 data flow may be 100 KWh (i.e., A′1+A1+P1+PN=20 KWh+20 KWh+30 KWh+30 KWh).

During another energy profile run, other KD data (e.g., KD2) may also be transmitted from sender end computer system 102 through a network adaptor port card (e.g., A1) and an input switch port card (e.g., P1), to output switch port card PN, and then to a network adaptor port card (e.g., A′1) at the receiver end computer system 104. During such a profile run, it may be determined from energy metering that the energy consumption (i.e., Power (Watts)×Time (hours)) of network adaptor port card A1 may be 30 KWh, the energy consumption of input switch port card P1 (switch 110) is 50 KWh, the energy consumption of the output Switch port card PN (switch 110) may be 50 KWh, and the energy consumption (i.e., Power (Watts)×Time (hours)) of network adaptor port card A′1 may be 30 KWh. As subsequently described below, the energy consumption determination associated with the switch port cards (e.g., P1 is 50 KWh) during this profile run may also be used to ascertain the baseline energy consumption value (i.e., an energy watermark or threshold value) for various switch devices along a designated route between sender and receiver end computer systems. Thus, the energy profile (Eₚ) for the KD2 data flow may be 160 KWh (i.e., A′1+A1+P1+PN=30 KWh+30 KWh+50 KWh+50 KWh).

At 204, a communication route for sending one or more KD flows between two end systems may be determined. For example, one communication route between computer system 102 and computer system 104 may include a route via switches 110 and 112 over link 1. An alternative communication route between computer system 102 and computer system 104 may include a route via switches 110 and 119 over link 2 and via switches 114 and 112 over link 3.

At 206, an end-to-end sender-to-receiver energy consumption value (E_{ec}) for the KD flows (e.g., KD1 and KD2) traversing the designated communication routes is determined based on the energy profile values. For example, if KD1 is sent from sender end computer system 102 to receiver end computer system 104 via the route including switches 110 and 112, based on the profiling run, each switch may have an energy consumption value of 60 KWh (i.e., for input & output port cards). Thus, over the communication route, the total energy consumption for the two switches 110, 112 is 120 KWh. Further, the end-to-end sender-to-receiver energy consumption value (E_{ec}) for the KD1 flow may be 160 KWh based on each network adaptor port card having an energy consumption value of 20 KWh based on the profile run, Thus, the total end-to-end sender-to-receiver energy consumption value (E_{ec}) for the KD1 flow may be 160 KWh (i.e., 60 KWh+60 KWh+20 KWh+20 KWh=160 KWh).

At 208, it is determined whether the end-to-end sender-to-receiver energy consumption value (E_{ec}) for the KD1 flow violates or exceeds an energy threshold given as a factor (β) of the energy profile (Eₚ) value. For example, if β is set to zero (0%), the threshold for the end-to-end sender-to-receiver energy consumption value (E_{ec}) may be equal to the energy profile value (Eₚ) for the KD1 flow. If, for example, β is set to 0.7 (70%), the threshold for the end-to-end sender-to-receiver energy consumption value (E_{ec}) may be 70% above the energy profile value (Eₚ) for the KD1 flow.

In the above-given example, if β=0, for the communication route to be selected (210), the end-to-end sender-to-receiver energy consumption value (E_{ec}) should be equal to or less than the energy profile value (Eₚ) for the KD1 flow. Since the total end-to-end sender-to-receiver energy consumption value (E_{ec}) for the KD1 flow is 160 KWh and the energy profile value (Eₚ) for the KD1 flow is 100 KWh, the condition is violated and another communication route is determined (204). If, however, β=0.7, for the communication route to be selected (210), the end-to-end sender-to-receiver energy consumption value (E_{ec}) should be equal to or less than 70% above the energy profile value (Eₚ) for the KD1 flow. Since the total end-to-end sender-to-receiver energy consumption value (E_{ec}) for the KD1 flow is 160 KWh and the energy profile value (Eₚ) for the KD1 flow is 100 KWh, the condition is not violated because the threshold is set at 70% above the 100 KWh value (i.e., 170 KWh). Therefore, the communication route may be selected (210).

At 212, it may be determined whether a predetermined number (N_{select}) of communication routes (Rₜ) is selected. For example, for N_{select}=1, then only one communication route may be selected. However, according to another example, for N_{select}=2, then another communication route may be selected (204). Here, if KD1 is sent from sender end computer system 102 to receiver end computer system 104 via a route including switches 110, 112, 116, and 118, based on the profiling run, each switch may have an energy consumption value of 60 KWh. Thus, over this communication route, the total energy consumption for the four switches 110, 112, 116, 118 is 240 KWh. Further, the end-to-end sender-to-receiver energy consumption value (E_{ec}) for the KD1 flow may be 280 Wh based on each network adaptor port card having an energy consumption value of 20 KWh based on the profile run, Thus, at 206, the total end-to-end sender-to-receiver energy consumption value (E_{ec}) for the KD1 flow along this alternative communication route may be 280 KWh (i.e., 60 KWh+60 KWh+60 KWh+60 KWh+20 KWh+20 KWh=280 KWh).

At 208, it is again determined whether the end-to-end sender-to-receiver energy consumption value (E_{ec}) for the KD1 flow violates or exceeds an energy threshold given as a factor (β) of the energy profile (Eₚ) value. For example, if β is set to zero (0%), the threshold for the end-to-end sender-to-receiver energy consumption value (E_{ec}) may be equal to the energy profile value (Eₚ) for the KD1 flow. If, for example, β is set to 0.7 (70%), the threshold for the end-to-end sender-to-receiver energy consumption value (E_{ec}) may be 70% above the energy profile value (Eₚ) for the KD1 flow.

In the above-given example, if β=0, for this communication route to be selected (210), the end-to-end sender-to-receiver energy consumption value (E_{ec}) should be equal to or less than the energy profile value (Eₚ) for the KD1 flow. Since the total end-to-end sender-to-receiver energy consumption value (E_{ec}) for the KD1 flow is 280 KWh and the energy profile value (Eₚ) for the KD1 flow is 100 KWh, the condition is violated and another communication route is determined (204). If, however, β=0.7, for the communication route to be selected (210), the end-to-end sender-to-receiver energy consumption value (E_{ec}) should be equal to or less than 70% above the energy profile value (Eₚ) for the KD1 flow. Since the total end-to-end sender-to-receiver energy consumption value (E_{ec}) for the KD1 flow is 280 KWh and the energy profile value (Eₚ) for the KD1 flow is 100 KWh, the condition is still violated because the threshold is set at 70% above the 100 KWh value (i.e., 170 KWh). Thus, the threshold condition (i.e., 170 KWh) remains violated by the end-to-end sender-to-receiver KD1 energy consumption value (E_{ec}) of 280 KWh. Therefore, the communication route is not selected and the process returns to 204.

Once one or more communication routes have been selected, at 214 a central EMA component sends an energy management control packet through the selected communication route for registering component energy consumption thresholds (or watermarks) (E1_{wm}→EN_{wm}) at each switch device and network adaptor EMA component along the route based on both the determined energy consumption values (E_{ec}) for the KD Data Flows and an energy consumption safety factor (E_{sf}) for any AD data flows that may be sent along the selected route. For example, EMA component 130 at the sender computer system 102 may be designated as the central EMA and send the energy management control packet along the route. Alternatively, for example, C-EMA 122 may send the energy management control packet along the route. For example, assuming the selected route between computer system 102 and 104 is via switch device 110 and 112, the KD1 and KD2 data flows may traverse through network adaptor port A1 of network adaptors 134, switch ports P1 (input) and PN (output) of switch device 110, switch ports P′1 (input) and P′N (output) of switch device 112, and network adaptor port A′1 of network adaptors 134.

As described in the above example, the energy profile (Eₚ) for the KD1 data flow may be 100 KWh (i.e., A′1+A1+P1+PN=20 KWh+20 KWh+30 KWh+30 KWh). Since during the profile run a single switch device's (i.e., Switch 110) port cards (P1 & PN) were determined to have an energy consumption value of 60 KWh for KD1, the two switches 110, 112 along the selected route will each include input and output (I/O) port cards (e.g., P1, PN, P′1, and P′N) having a designated energy consumption value of 30 KWh (i.e., P1 (15 KWh)+PN (15 KWh)=30 KWh; and P′1 (15 KWh)+P′N (15 KWh)=30 KWh). Also described above, the energy profile (Eₚ) for the KD2 data flow may be 160 KWh (i.e., A′1+A1+P1+PN=30 KWh+30 KWh+50 KWh+50 KWh). Since during the profile run the single switch's (i.e., Switch 110) port cards (P1 & PN) were determined to have an energy consumption value of 100 KWh (i.e., P1=50 KWh, PN=50 KWh) for KD2, the two switches 110, 112 along the selected route will have input and output port cards (e.g., P1, PN, P′1, and P′N) including a designated energy consumption value of 50 KWh (i.e., P1 (25 KWh)+PN (25 KWh)=50 KWh; and P′1 (25 KWh)+P′N (25 KWh)=50 KWh). The energy consumption of 100 KWh for one switch during the profile run is divided to include the total number of switches along the route, whereby here, two switches 110, 112 are utilized. Thus, based on the KD1 and KD2 data flows traversing the selected route, the two switches 110, 112 will each have port cards P1, PN, P′1, P′N that include a designated watermark or threshold value of 40 KWh (i.e., 15 KWh+25 KWh) derived from the sum of the designated energy consumption values for each KD flow.

Based on the KD1 profile run, the energy consumption of the network adaptor port A1 at computer system 102 may have a value of 20 KWh for KD1 data and 30 KWh for KD2 data. Thus, the network adaptor port A1 at computer 102 may have a designated watermark or threshold value set to 50 KWh (i.e., 20 KWh+30 KWh). Similarly, based on the KD2 profile run, the energy consumption of the network adaptor port A′1 at computer system 104 may have a value of 20 KWh for KD1 data and 30 KWh for KD2 data. Thus, the network adaptor port A′1 at computer 104 may also have a designated watermark or threshold value set to 50 KWh (i.e., 20 KWh+30 KWh) derived from the sum of the designated energy consumption values for each KD flow. Based on these calculated watermark or threshold energy consumption values, for example, EMA component 130 generates an energy management control packet that traverses between computer systems 102 and 104 via switches 110 and 112. The EMA 130 registers the watermark or threshold energy consumption value for network adaptor port A1 and sends an energy management control packet to switch 110, switch 112, and computer system 104. At switch 110, the CPP EMA component 150 may receive the switches 110 watermark or threshold energy consumption value for port card P1 and PN from the energy management control packet. At switch 112, the CPP EMA component 160 may also receive the switches 112 watermark or threshold energy consumption value for port card P′1 and P′N from the energy management control packet. Similarly, at computer system 104, EMA component 140 receives the network adaptor port A′1 watermark or threshold energy consumption value from the energy management control packet. For each of the network adaptor ports and switch ports, an additional energy consumption threshold value (E_{sf}) may be added as a safety factor in order to take into account AD data flows along the selected communication route.

At 216, the KD flows (i.e., KD1 and KD2) are now transmitted between computer systems 102 and 104 via switch devices 110 and 112.

Referring now to FIG. 2B, at 220 the EMA components associated with each switch port and adaptor port along the selected route record the energy consumption values (E1_{cc}→EN_{cc}) at each of the switch port and adaptor ports based on both the KD and AD data flows traversing the route. As previously indicated, at each switch port or network adaptor port, an energy consumption metering device may be used to measure energy consumption, which is then sampled and recorded by a respective EMA. For example, along the selected route, the data flows are transmitted from network adaptor port A1 of computer system 102 to network adaptor port A′1 of computer system 104 via switch ports P1 and PN of switch 110 and switch ports P′1 and P′N of switch 112. Accordingly, EMA component 130 may record the energy consumption value of adaptor port A1, CPP EMA component 150 may record the energy consumption value of switch ports P1 and PN, CPP EMA component 160 may record the energy consumption value of switch ports P′1 and P′N, and EMA component 140 may record the energy consumption value of adaptor port A′1.

At 222, it may be determined whether, based of certain quality of service (QoS) requirements, multiple routes between the end-system computers are needed. For example, if network latency parameters are exceeded, a single route for transmitting the data flows may not be enough to satisfy such latency criteria. Thus, multiple routes may be selected and used between the end system computers. As previously described, processes 204-210 (FIG. 2A) may determine multiple routes from which the most energy efficient route may be initially selected. The remaining determined routes may be used, however, for routing-redundancy and/or QoS issues. Here, for example, based on a QoS concern (e.g., latency), multiple determined routes may be used in addition to the initial selected route (230). Once multiple routes have been selected, each of the routes may be weighted to receive a KD data flow amount based on each of the multiple route sender-to-receiver energy consumption values. For example, if three (3) routes have substantially the same sender-to-receiver energy consumption values, the routes may have an equal weighting (i.e., 0.33) and, therefore, receive substantially the same amount of KD data. If, for example, one of the three (3) routes (i.e., R1) has half the sender-to-receiver energy consumption values than the other two routes (i.e., R2, R3), R1 may carry twice the amount of KD data compared to routes R2 and R3. Thus, R1 may have a weighting of 0.5, while R2 and R3 may have a weighting of 0.25. It may be appreciated that the multiple routes may also receive component energy consumption thresholds from the central EMA control packet using process 214 (FIG. 2A). At 234, the EMA components associated with each switch port and adaptor port along the multiple routes record the energy consumption values at each of the switch port and adaptor ports based on both the KD and AD data flows traversing the multiple routes. As previously indicated, at each switch port or network adaptor port, an energy consumption metering device may be used to measure energy consumption, which is then sampled and recorded by a respective EMA.

If at 222 it is determined that based of certain quality of service (QoS) requirements no multiple routes are needed, then at 224, the recorded energy consumption values (E1_{cc}→EN_{cc}) along the selected route (220) are compared with the component energy consumption thresholds (E1_{wm}→EN_{wm}) registered along the route (FIG. 2A: 214). If the recorded energy consumption values (E1_{cc}→EN_{cc}) along the selected route (220) are all less than the respective component energy consumption thresholds (E1_{wm}→EN_{wm}) registered along the route (FIG. 2A: 214), the KD data flows continue to be sent (FIG. 2A: 216). If, however, any of the recorded energy consumption values (E1_{cc}→EN_{cc}) of the switch or network adaptor ports along the selected route (220) exceed a respective component energy consumption threshold (E1_{wm}→EN_{wm}) registered along the route (FIG. 2A: 214), at 226 it may be determined whether energy credits are available for that violating switch port or adaptor port along the route. For example, if the recorded energy consumption value of switch port P1 at switch 110 exceeds the energy consumption threshold of port P1 (224), the CPP EMA 150 of the switch 110 may request the availability of energy credits based on a predetermined energy budget (226). In one implementation, available energy credit amounts may be distributed by the central EMA to all other EMA components. In such an implementation, any available credits may be stored locally on the EMA of the switch port or adaptor port that exceeds its energy threshold. According to another implementation, the EMA of the switch port or adaptor port that exceeds its energy threshold may initiate an energy request from the central EMA. The central EMA may store the predetermined energy budget and receive energy consumption update data from all EMA components. Thus, the central EMA may dynamically compute available energy credits for distribution. Energy credits may be a predefined energy consumption value that may be assigned to any switch or network adaptor device that has exceeded its total I/O energy consumption threshold values (E_{cwm}). The predefined energy consumption value constituting available energy credits may be designated by a network administrator. For example, 20 KWh of energy credits may be designated as being available for use along a communication route. If a switch along the route exceeds its energy consumption threshold by 10 KWh, from the 20 KWh of energy credits, 10 KWh of energy credit may be assigned to the switch by, for example, the central EMA.

If, at 226, it is determined that no energy credits are available, the central EMA may send a control frame to the sender end system indicating that the energy consumption along the communication path has been exceeded and to pause KD data transmission (228). For example, if the recorded energy consumption value of switch port P1 at switch 110 exceeds the energy consumption threshold of port P1 (224) and no energy credits are available (226), the CPP EMA 150 of the switch 110 may then communicate the energy consumption violation to the central EMA 130 located at sender-end computer system 102. The central EMA 130 located at sender-end computer system 102 may then subsequently send a control frame to the CPU 132 in order to pause data transmission of the KD flows. Alternatively, the CPP EMA 150 of the switch 110 may communicate the energy consumption violation to central EMA 122. The central EMA 122 may subsequently send a control frame to the EMA 130 located at sender-end computer system 102. The EMA 130 may then instruct the CPU 132 to pause data transmission of the KD flows.

If at 222 it is determined that based of certain quality of service (QoS) requirements multiple routes are not needed, then described process flows 224-228 are followed for each route used.

Referring to FIG. 2C, if, at 226 (FIG. 2B), it is determined that energy credits are available, then, the amount of available energy credits (Eₐᵥ) are determined (236). The available energy credits (Eₐᵥ) may be determined by subtracting the total determined component energy watermark values (Σ[E1_{wm}→EN_{wm}]) along the selected route from the predetermined energy budget. For example, based on the above exemplary description, the total determined component energy watermark values (Σ[E1_{wm}→EN_{wm}]) along the selected route from computer 102 to computer 104 over switches 110 and 112 may be 180 KWh (i.e., A1_{watermark}+A′1_{watermark}+P1_{watermark}+PN_{watermark}+P′1_{watermark}+P′N_{watermark}=50 KWh+50 KWh+40 KWh+40 KWh+40 KWh+40 KWh=260 KWh). Also, a predetermined energy budget of 500 KWh may, for example, be designated for a datacenter that includes computer systems 102 and 104, and switches 110 and 112. Based on this example, the available energy credits are the difference between the predetermined energy budget (i.e., 500 KWh) and the total determined component energy watermark values (i.e., 260 KWh) along the selected route. Thus, the available energy credits are 240 KWh (i.e., 500 KWh−260 KWh).

At 238, energy credits are assigned from the determined available energy credits (Eₐᵥ) to the switch port or network adaptor port that exceeds their corresponding energy consumption threshold or watermark value. For example, if switch port P1 exceeds its energy threshold value of 40 KWh by 20 KWh, then 20 KWh of energy credits may be requested by the switch 110 EMA component 150 from the designated central EMA 130. Subsequently, the central EMA 130 may assign to the switch port P1 the 20 KWh of energy credits from the available energy credits (Eₐᵥ) of 240 KWh. At 240, the central EMA updates the available energy credits based on what energy credits it assigns. Thus, in the example, the 20 KWh of assigned energy credits are subtracted from the available energy credits (Eₐᵥ) of 240 KWh to produce an updated energy credit value of 220 KWh (i.e., 240 Wh−20 KWh). Since energy credits are available (226, 236) and assigned (238), the process of sending KD flows continues at process 216 (FIG. 2A).

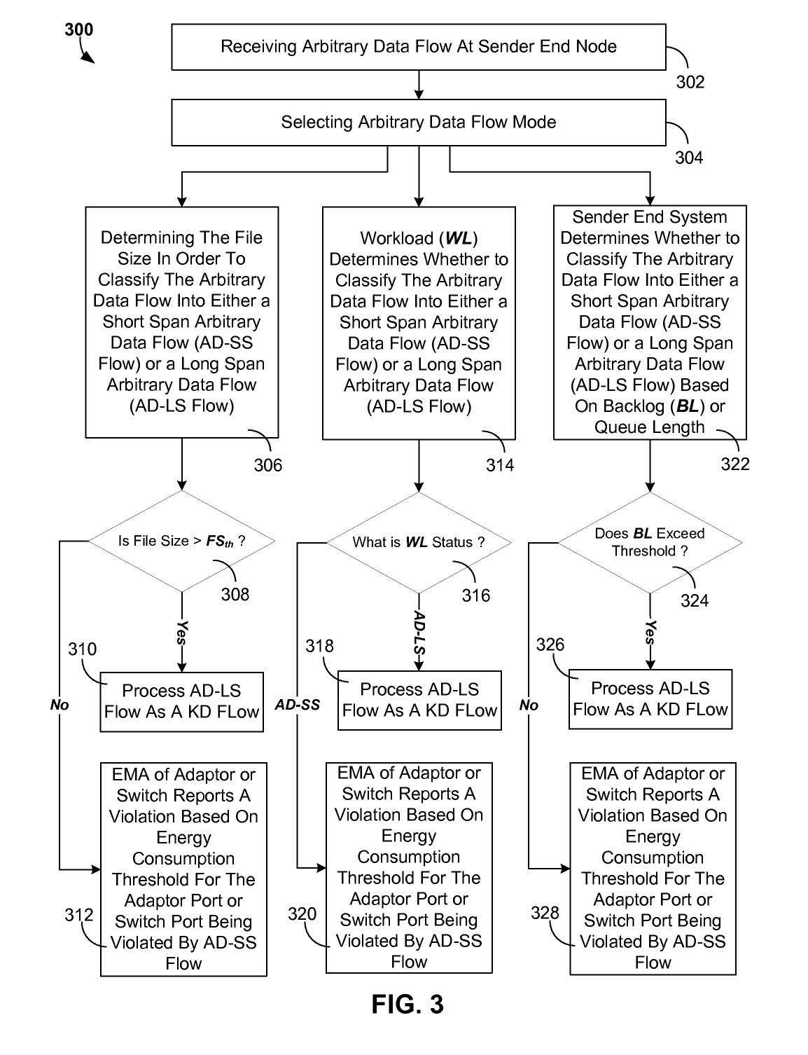

Referring to FIG. 3, an operational flow diagram 300 of a data classification process associated with arbitrary data flows according to an exemplary embodiment is illustrated. The operational flow diagram 300 describes classifying certain AD flows as KD flow. Once these AD flows are classified as KD flows, they may be subsequently processed according to the processes described above in relation to FIGS. 2A-2C. The operational flow diagram 300 of FIG. 3 may be described with the aid of the exemplary communication system 100 depicted in FIG. 1.

At 302, an AD flow may be received at a sender end node or system such as computer system 102. The flows may be classified as AD flows based on, for example, not having profile run information. The EMA component 130 at computer system 102 may then initiate an AD flow selection mode process (304). Three flow mode determination criteria may be utilized.

For example, at 306 the file size of the received AD data may be determined in order to classify the received data flow into either an arbitrary short span data (AD-SS) flow or an arbitrary long span data (AD-LS) flow. If at 308, the file size is determined to be greater than a predetermined threshold (FSₜₕ), the received AD data may be classified as an arbitrary long span data (AD-LS) flow (310). The arbitrary long span data (AD-LS) flow is then processed as a KD flow according to the processes described in relation to FIGS. 2A-2C (310). If at 308, the file size is determined to be less than a predetermined threshold (FSₜₕ), the received AD data may be classified as an arbitrary short span data (AD-SS) flow (312). Accordingly, the EMA of the switch or network adaptor receiving such data may report a violation based on the energy consumption threshold value of a respective adaptor port or switch port being exceeded by the AD-SS flow. The EMA may then send the report to a central EMA to be logged. For example, if the AD-SS flow causes the energy consumption threshold value of switch port P1 to be exceeded, the CPP-EMA 150 of the switch 110 may send a violation report to EMA 130 provided this EMA is a designated central EMA. In an alternative implementation, the CPP-EMA 150 of the switch 110 may send the violation report to C-EMA 122. Thus, AD data classified as AD-SS flows are not processed as KD flows for energy management purposes.

At 314 the workload (WL) of the received AD data may be determined in order to classify the received data flow into either an arbitrary short span data (AD-SS) flow or an arbitrary long span data (AD-LS) flow. The workload may be determined by, for example, a particular application program that generates data. Based on the application program, each workload may be classified as generating either an arbitrary short span data (AD-SS) flow or an arbitrary long span data (AD-LS) flow. For example, Application-X may be designated as generating a workload having AD-LS data, while Application-Y may be designated as generating a workload having AD-SS data. Accordingly, at 316 the WL status may be determined based on how the WL is classified.

If at 316, the WL status is determined to be that of an arbitrary long span data (AD-LS) flow, the arbitrary long span data (AD-LS) flow is then processed as a KD flow according to the processes described in relation to FIGS. 2A-2C (318). If at 316, the WL status is determined to be that of an arbitrary short span data (AD-SS) flow, the EMA of the switch or network adaptor receiving such data may report a violation based on the energy consumption threshold value of a respective adaptor port or switch port being exceeded by the AD-SS flow (320). The EMA may then send the report to a central EMA to be logged (320). For example, if the AD-SS flow causes the energy consumption threshold value of switch port P1 to be exceeded, the CPP-EMA 150 of the switch 110 may send a violation report to EMA 130 provided this EMA is a designated central EMA. In an alternative implementation, the CPP-EMA 150 of the switch 110 may send the violation report to C-EMA 122. Thus, AD data classified as AD-SS flows are not processed as KD flows for energy management purposes.

For example, at 322 the size of the received AD data that is buffered and back logged (BL) by a data buffer associated with the sender end system (e.g., FIG. 1: computer system 102) may be determined in order to classify the received data flow into either an arbitrary short span data (AD-SS) flow or an arbitrary long span data (AD-LS) flow. If at 324, the size of the BL data in the data buffer is determined to be greater than a predetermined threshold, the received AD data may be classified as an arbitrary long span data (AD-LS) flow (326). The arbitrary long span data (AD-LS) flow is then processed as a KD flow according to the processes described in relation to FIGS. 2A-2C (326). If at 324, the BL data within the data buffer is determined to be less than a predetermined threshold, the received AD data may be classified as an arbitrary short span data (AD-SS) flow (328). Accordingly, the EMA of the switch or network adaptor receiving such data may report a violation based on the energy consumption threshold value of a respective adaptor port or switch port being exceeded by the AD-SS flow. The EMA may send the report to a central EMA to be logged. For example, if the AD-SS flow causes the energy consumption threshold value of switch port P1 to be exceeded, the CPP-EMA 150 of the switch 110 may send a violation report to EMA 130 provided this EMA is a designated central EMA. In an alternative implementation, the CPP-EMA 150 of the switch 110 may send the violation report to C-EMA 122. Thus, AD data classified as AD-SS flows are not processed as KD flows for energy management purposes.

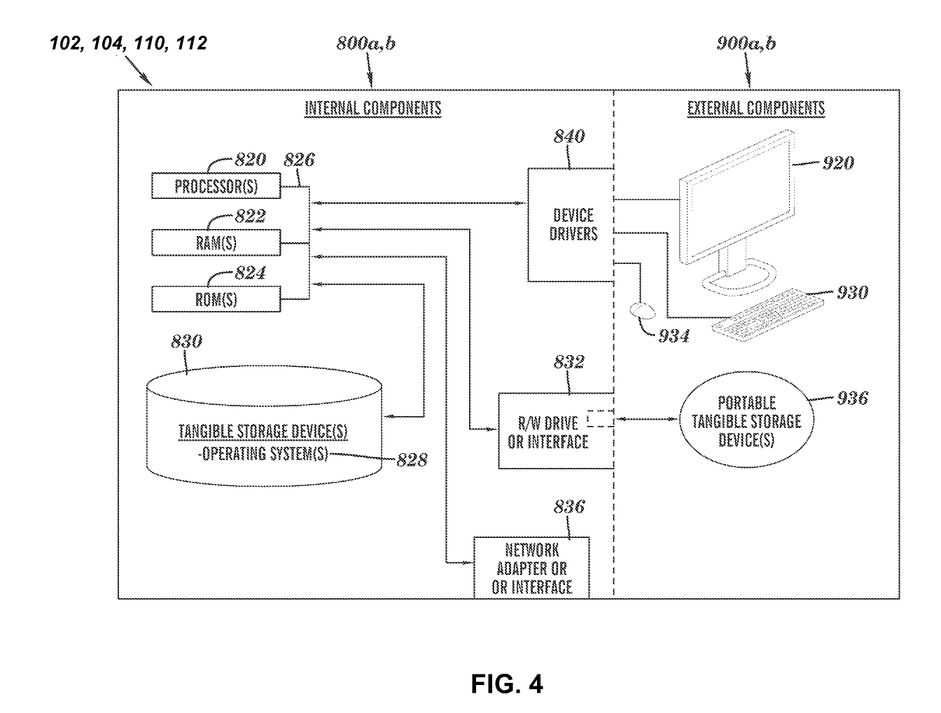

FIG. 4 shows a block diagram of the components of a data processing system 800, 900, such as computing devices 102, 104, 110, and 112 (FIG. 1) in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Computing devices 102, 104, 110, and 112 (FIG. 1) may include respective sets of internal components 800 a, b, c and external components 900 a, b, c illustrated in FIG. 4. Each of the sets of internal components 800 a, b, c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs in respective computing devices 102, 104, 110, and 112 (FIG. 1) is stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, c also includes a R/W drive or interface 832 to read from and write to one or more portable computer-readable tangible storage devices 936 such as a CD-ROM, DVD, memory stick, magnetic tape, magnetic disk, optical disk or semiconductor storage device. The EMA component programs 200 (FIGS. 2A-2C), 300 (FIG. 3) associated with computing devices 102, 104, 110, and 112 (FIG. 1) can be stored on one or more of the respective portable computer-readable tangible storage devices 936, read via the respective R/W drive or interface 832 and loaded into the respective hard drive 830.

Each set of internal components 800 a, b, c may also include network adapters (or switch port cards) or interfaces 836 such as a TCP/IP adapter cards, wireless wi-fi interface cards, or 3G or 4G wireless interface cards or other wired or wireless communication links. EMA component programs 200 (FIGS. 2A-2C) and 300 (FIG. 3), in computing devices 102, 104, 110, and 112 (FIG. 1) can be downloaded to computing devices 102, 104, 110, and 112 (FIG. 1) from an external computer (e.g., server) via a network (for example, the Internet, a local area network or other, wide area network) and respective network adapters or interfaces 836. From the network adapters (or switch port adaptors) or interfaces 836, the EMA component programs 200 (FIGS. 2A-2C) and 300 (FIG. 3) associated with computing devices 102, 104, 110, and 112 (FIG. 1) are loaded into the respective hard drive 830. The network may comprise copper wires, optical fibers, wireless transmission, routers, firewalls, switches, gateway computers and/or edge servers.

Each of the sets of external components 900 a, b, c can include a computer display monitor 920, a keyboard 930, and a computer mouse 934. External components 900 a, b, c can also include touch screens, virtual keyboards, touch pads, pointing devices, and other human interface devices. Each of the sets of internal components 800 a, b, c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A method of managing data flow between a first node and a second node within a communication network, the method comprising:
determining data flows as at least one of data flows of known duration and data flows of arbitrary duration;
determining profile energy consumption values for each of the data flows of known duration based on transmitting the data flows of known duration between the first and the second node via a first network adaptor port card associated with the first node, a second network adaptor port card associated with the second node, and switch port cards for communicatively coupling the first and the second network adaptor port card;
determining one or more energy efficient routes for transmitting the data flows of known duration between the first and the second node over the communication network; and
determining, based on the profile energy consumption values, network element reference energy consumption values for each of network adaptor port cards and each of switch port cards located along the one or more energy efficient routes,
wherein transmission of the data flows of known duration is based on energy consumption values at each of network adaptor port cards and each of switch port cards not exceeding a respective one of the network element reference energy consumption values.

2. The method of claim 1, wherein the determining of the plurality of energy efficient routes comprises:
determining an end-to-end energy consumption value for each of the plurality routes based on the determined profile energy consumption values; and
selecting one or more energy efficient routes from the plurality of routes based on the end-to-end energy consumption values being within a predetermined factor above the determined profile energy consumption values.

3. The method of claim 1, wherein the determining of the profile energy consumption value comprises:
determining, for each of the data flows of known duration, a first energy consumption value for the first network adaptor port card;
determining, for each of the data flows of known duration, a second energy consumption value for the second network adaptor port card;
determining, for each of the data flows of known duration, a third energy consumption value for the switch port cards; and
summing, for each of the data flows of know duration, the first, the second, and the third energy consumption value.

4. The method of claim 1, wherein the network element reference energy consumption values are based on allocating an energy consumption safety margin associated with the data flows of arbitrary duration.

5. The method of claim 1, wherein the first node comprises a computer data center that sends the data flows.

6. The method of claim 1, wherein the second node comprises a computer data center that receives the data flows.

7. The method of claim 1, wherein the energy consumption values at each of network adaptor port cards and each of switch port cards are measure by an energy metering integrated circuit (IC) device associated with each of network adaptor port cards and each of switch port cards.

8. The method of claim 1, wherein the communication network comprises a storage area network (SAN).

9. The method of claim 1, further comprising:
assigning energy credits to each of the network adaptor port cards and each of the switch port cards when the energy consumption values at each of the network adaptor port cards and each of the switch port cards exceeds the network element reference energy consumption values for each of the network adaptor port cards and each of the switch port cards.

10. The method of claim 9, wherein the assigning of energy credits comprises:
accessing a predetermined energy budget value for a fixed interval of time;
determining an aggregate energy consumption value based on the network element reference energy consumption values for each of the network adaptor port cards and each of the switch port cards; and
calculating an available energy credits value based on the difference between the predetermined energy budget value and the aggregate energy consumption value.

11. The method of claim 10, further comprising:
pausing the transmission of the data flows of know duration when the aggregate energy consumption value is substantially the same as or exceeds the predetermined energy budget value.

12. The method of claim 1, wherein the data flows of arbitrary duration comprise Internet traffic.

13. The method of claim 1, wherein the determining of the data flows as at least one of data flows of known duration and data flows of arbitrary duration comprises:
assigning the data flows of arbitrary duration as the data flows of known duration based on file size of the data flows of arbitrary duration.

14. The method of claim 13, wherein the data flows of arbitrary duration are assigned as the data flows of known duration when the file size exceeds a predetermined limit.

15. The method of claim 1, wherein the determining of the data flows as at least one of data flows of know duration and data flows of arbitrary duration comprises:
assigning the data flows of arbitrary duration as the data flows of known duration based a designated workload.

16. The method of claim 15, wherein the designated workload comprises an application program running on one of the first node and the second node.

17. The method of claim 1, wherein the determining of the data flows as at least one of data flows of known duration and data flows of arbitrary duration comprises:
assigning the data flows of arbitrary duration as the data flows of known duration based the data flows of arbitrary duration being stored in a data buffer prior to transmission and the data buffer capacity exceeding a threshold.

18. The method of claim 17, wherein the threshold comprises about a user defined fraction of the data buffer capacity.

19. A computer system for managing data flow between a first node and a second node within a communication network comprising:
a memory;
a processor in communication with the memory, the processor comprising an instruction fetching unit for fetching instructions from memory and one or more execution units for executing fetched instructions;
wherein said computer system is capable of performing a method comprising:
determining, by a processor, data flows as at least one of data flows of known duration and data flows of arbitrary duration;
determining, by the processor, profile energy consumption values for each of the data flows of known duration based on transmitting the data flows of known duration between the first and the second node via a first network adaptor port card associated with the first node, a second network adaptor port card associated with the second node, and switch port cards for communicatively coupling the first and the second network adaptor port card;
determining, by the processor, one or more energy efficient routes for transmitting the data flows of known duration between the first and the second node over the communication network; and
determining, by the processor, based on the profile energy consumption values, network element reference energy consumption values for each of network adaptor port cards and each of switch port cards located along the one or more energy efficient routes,
wherein transmission of the data flows of known duration is based on energy consumption values at each of network adaptor port cards and each of switch port cards not exceeding a respective one of the network element reference energy consumption values.

20. A computer program product for storing a computer program for managing data flow between a first node and a second node within a communication network, the computer program product comprising a storage medium readable by a processing circuit and storing instructions for execution by the processing circuit for performing a method comprising:
determining data flows as at least one of data flows of known duration and data flows of arbitrary duration;
determining profile energy consumption values for each of the data flows of known duration based on transmitting the data flows of known duration between the first and the second node via a first network adaptor port card associated with the first node, a second network adaptor port card associated with the second node, and switch port cards for communicatively coupling the first and the second network adaptor port card;
determining one or more energy efficient routes for transmitting the data flows of known duration between the first and the second node over the communication network; and
determining, based on the profile energy consumption values, network element reference energy consumption values for each of network adaptor port cards and each of switch port cards located along the one or more energy efficient routes,
wherein transmission of the data flows of known duration is based on energy consumption values at each of network adaptor port cards and each of switch port cards not exceeding a respective one of the network element reference energy consumption values.
